(19) United States
(12) Patent Application Publication
(10) Pub. No.: US 2026/0316805 A1
(43) Pub. Date: Oct. 15, 2026

(54) METHODS AND SYSTEMS FOR DETECTING MOVING VEHICLES

(71) Applicant: Hifi Engineering Inc., Calgary (CA)

(72) Inventors: Amandeep Parmar, Calgary (CA); Seyed Ehsan Jalilian, Calgary (CA)

(21) Appl. No.: 19/486,264

(22) PCT Filed: May 23, 2024
(86) PCT No.: PCT/CA2024/050685

§ 371 Date: Nov. 20, 2025

Related U.S. Application Data
(60) Provisional application No. 63/469,315, filed on May 26, 2023.

(51) Int. Cl. B61L 25/02; G01D 5/353; G01M 5/00; G01P 13/00

(52) U.S. Cl. CPC B61L 25/026; G01D 5/35316; G01M 5/0091; G01P 13/00

(57) ABSTRACT

The present disclosure provides methods and systems for detecting moving vehicles travelling on transportation infrastructure by evaluating strain data of an optical fiber disposed at a location in proximity to the transportation infrastructure. The strain data is classified, which comprises using a classifier trained to identify a vehicle signature in the strain data indicative of a vehicle travelling on the transportation infrastructure. An occurrence of a vehicle event is determined based on an identification of the vehicle signature in the strain data, and an indication of the vehicle event is output.

### CROSS-REFERENCE TO RELATED APPLICATIONS

This application claims priority to U.S. Provisional Patent Application No. 63/469,315, filed on May 26, 2023, the entire contents of which is incorporated herein by reference for all purposes.

### TECHNICAL FIELD

The present disclosure relates to methods, systems, and techniques for detecting moving vehicles.

### BACKGROUND

It can be useful to be able to identify moving vehicles travelling on transportation infrastructure, such as trains travelling on train tracks, motor vehicles on roadways, etc. Accordingly, additional, alternative, and/or improved methods, systems, and techniques for detecting moving vehicles remain desirable.

### SUMMARY

According to a first aspect, there is provided a method of detecting moving vehicles, comprising: receiving strain data from one or more channels of an optical fiber disposed at a location in proximity to transportation infrastructure; classifying the strain data, wherein classifying the strain data comprises using a classifier trained to identify a vehicle signature in the strain data indicative of a vehicle travelling on the transportation infrastructure; determining occurrence of a vehicle event based on an identification of the vehicle signature in the strain data; and outputting an indication of the vehicle event.

In some aspects, classifying the strain data comprises classifying the strain data received from each of the one or more channels respectively.

In some aspects, the strain data is received from a plurality of channels of the optical fiber arranged perpendicular to the transportation infrastructure, and wherein the vehicle event is determined to have occurred when the vehicle signature is identified in a threshold percentage of the plurality of channels.

In some aspects, the strain data is received from a plurality of channels of the optical fiber arranged parallel or at an angle between parallel and perpendicular to the transportation infrastructure, and wherein the vehicle event is determined to have occurred based on a pattern of channels on which the vehicle signature was identified.

In some aspects, the method further comprises determining one or both of: a speed of the vehicle, based on a time between identifying the vehicle signature on different channels; and a direction of the vehicle, based on an order of channels on which the vehicle signature was identified.

In some aspects, the method further comprises determining an estimated time of arrival of the vehicle at a point of interest based on the speed of the vehicle and the direction of the vehicle.

In some aspects, the transportation infrastructure is a train track, and the method comprises determining that the vehicle event is caused by a motor vehicle on the train track by detecting at least one of the following based on the pattern of channels on which the vehicle signature was identified: movement on the train track that reverses direction; movement on the train track that changes to an idle for a time greater than a predetermined idle threshold; and movement on the train track for a time greater than a predetermined train passing threshold.

In some aspects, the transportation infrastructure is a train track, and the classifier is trained to classify the vehicle signature in the strain data as a train signature or a motor vehicle signature travelling on the train track.

In some aspects, the classifier is further trained to classify the train signature as corresponding to a freight train or a light rail transit train.

In some aspects, the transportation infrastructure is a roadway, and the classifier is trained to classify the vehicle signature in the strain data as a motor vehicle signature travelling on the roadway.

In some aspects, the classifier is further trained to classify the motor vehicle signature according to a type of vehicle comprising one of: a passenger vehicle, a transport truck, and a bus.

In some aspects, the method further comprises: evaluating the strain data against one or more strain magnitude thresholds, the strain magnitude thresholds set to distinguish vehicle movement on the transportation infrastructure; and wherein determining occurrence of the vehicle event is further based on the strain data satisfying the corresponding strain magnitude threshold.

In some aspects, the one or more strain magnitude thresholds comprise one or more of an acoustic strain threshold and an absolute strain threshold.

In some aspects, the strain data classified by the classifier is an acoustic signal measured in the one or more channels of the optical fiber.

In some aspects, the strain data is received from a strain sensor configured to measure strain in the one or more channels of the optical fiber, the strain sensor comprising an optical interrogator and at least one pair of fiber Bragg gratings (FBGs), each pair of FBGs corresponding to respective of the one or more channels, and each pair of FBGs tuned to reflect substantially identical wavelengths.

According to another aspect, there is provided a non-transitory computer readable medium having stored thereon computer program code that is executable by a processor and that, when executed by the processor, causes the processor to perform the method of any one of the above aspects.

According to another aspect, there is provided a vehicle detection system, comprising: an optical fiber disposed at a location in proximity to transportation infrastructure, the optical fiber comprising one or more channels each having at least one pair of fiber Bragg gratings tuned to reflect substantially identical wavelengths; an optical interrogator optically coupled to the optical fiber and configured to perform optical interferometry using the optical fiber; and a processing device communicatively coupled to the optical interrogator, wherein the processing device is configured to perform the method of any one of the above aspects.

According to another aspect, there is provided a method of training a classifier to classify strain data received from one or more channels of an optical fiber and to identify a vehicle signature in the strain data, the method comprising: obtaining training strain data, wherein the training strain data has a known vehicle signature; and training the classifier to classify the vehicle signature using the training strain data.

In some aspects, the known vehicle signature is at least one of a known train signature and a known motor vehicle signature.

In some aspects, the known train signature comprises one or both of a known freight train signature and a known light rail transit train signature.

In some aspects, the known motor vehicle signature comprises one or more of a known passenger vehicle signature, a known transport truck signature, and a known bus signature.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1A is a block diagram of an optical interrogation system including an optical fiber with fiber Bragg gratings (“FBGs”) for reflecting a light pulse, in accordance with embodiments of the disclosure;

FIG. 1B is a schematic diagram that depicts how the FBGs reflect a light pulse, in accordance with embodiments of the disclosure;

FIG. 1C is a schematic diagram that depicts how a light pulse interacts with impurities in an optical fiber that results in scattered laser light due to Rayleigh scattering, which is used for distributed acoustic sensing (“DAS”), in accordance with embodiments of the disclosure;

FIG. 2 depicts a representation of a train detection system in accordance with embodiments of the present disclosure;

FIG. 3 shows a method of detecting moving vehicles in accordance with embodiments of the present disclosure;

FIG. 4 shows an example of train detection using strain data in accordance with embodiments of the present disclosure;

FIGS. 5A-D show examples of strain data of train events in accordance with embodiments of the present disclosure;

FIG. 6 shows an example of a user interface generated in accordance with embodiments of the present disclosure;

FIGS. 7A and 7B show strain data obtained for testing the classifier;

FIGS. 8A-C show examples of strain data of a motor vehicle detected on a train track in accordance with embodiments the present disclosure; and

FIG. 9 shows a method of training a classifier in accordance with embodiments of the present disclosure.

### DETAILED DESCRIPTION

Fiber optic cables are often used as distributed measurement systems in acoustic sensing applications. Pressure changes, due to sound waves for example, in the space immediately surrounding an optical fiber and that encounter the optical fiber cause dynamic strain in the optical fiber. Optical interferometry may be used to detect the dynamic strain along a segment of the fiber. Optical interferometry is a technique in which two separate light pulses, a sensing pulse and a reference pulse, are generated and interfere with each other. The sensing and reference pulses may, for example, be directed along an optical fiber that comprises fiber Bragg gratings. The fiber Bragg gratings partially reflect the pulses back towards an optical receiver at which an interference pattern is observed.

The nature of the interference pattern observed at the optical receiver provides information on the optical path length the pulses traveled, which in turn provides information on parameters such as the strain experienced by the segment of optical fiber between the fiber Bragg gratings. Information on the strain then provides information about the event that caused the strain.

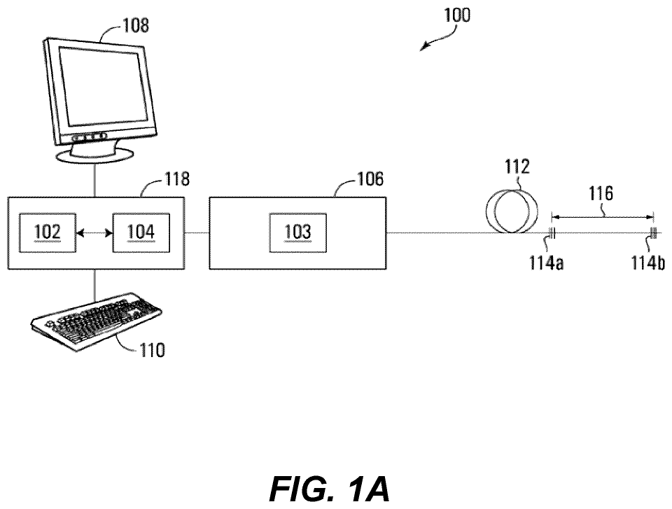

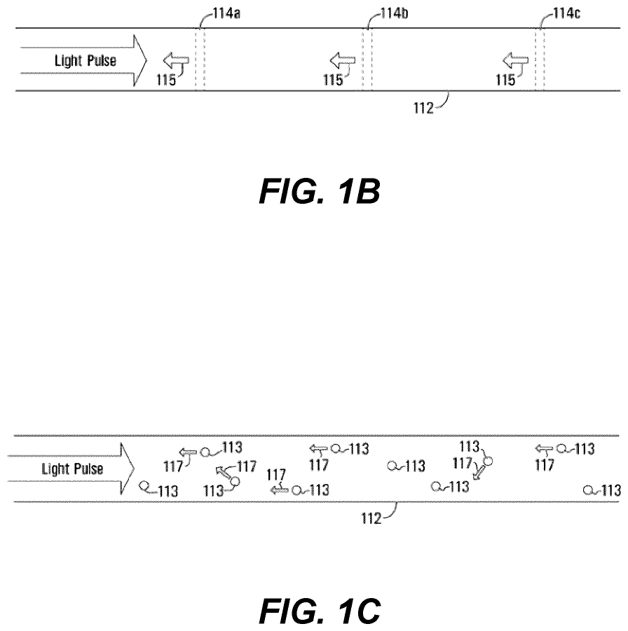

Referring now to FIG. 1A, there is shown one embodiment of a system 100 for performing interferometry using fiber Bragg gratings (“FBGs”), in accordance with embodiments of the disclosure. The system 100 comprises optical fiber 112, an interrogator 106 optically coupled to the optical fiber 112, and a signal processing device 118 that is communicative with the interrogator 106.

The optical fiber 112 comprises one or more fiber optic strands, each of which is made from quartz glass (amorphous SiO₂). The fiber optic strands are doped with various elements and compounds (including germanium, erbium oxides, and others) to alter their refractive indices, although in alternative embodiments the fiber optic strands may not be doped. Single mode and multimode optical strands of fiber are commercially available from, for example, Corning® Optical Fiber. Example optical fibers include ClearCurve™ fibers (bend insensitive), SMF28 series single mode fibers such as SMF-28 ULL fibers or SMF-28e fibers, and InfiniCor® series multimode fibers.

The interrogator 106 generates the sensing and reference pulses and outputs the reference pulse after the sensing pulse. The pulses are transmitted along optical fiber 112 that comprises a first pair of FBGs. The first pair of FBGs comprises first and second FBGs 114a,b (generally, “FBGs 114”). The first and second FBGs 114a,b are separated by a certain segment 116 of the optical fiber 112 (“fiber segment 116”). The optical length of the fiber segment 116 varies in response to dynamic strain that the fiber segment 116 experiences.

The light pulses have a wavelength identical or very close to the center wavelength of the FBGs 114, which is the wavelength of light the FBGs 114 are designed to partially reflect; for example, typical FBGs 114 are tuned to reflect light in the 1,000 to 2,000 nm wavelength range. The sensing and reference pulses are accordingly each partially reflected by the FBGs 114a,b and return to the interrogator 106. The delay between transmission of the sensing and reference pulses is such that the reference pulse that reflects off the first FBG 114a (hereinafter the “reflected reference pulse”) arrives at the optical receiver 103 simultaneously with the sensing pulse that reflects off the second FBG 114b (hereinafter the “reflected sensing pulse”), which permits optical interference to occur.

While FIG. 1A shows only the one pair of FBGs 114a,b, in alternative embodiments (not depicted) any number of FBGs 114 may be on the fiber 112, and time division multiplexing (TDM) (and, optionally, wavelength division multiplexing (WDM)) may be used to simultaneously obtain measurements from them. If two or more pairs of FBGs 114 are used, any one of the pairs may be tuned to reflect a different center wavelength than any other of the pairs. Alternatively, a group of multiple FBGs 114 may be tuned to reflect a different center wavelength to another group of multiple FBGs 114, and there may be any number of groups of multiple FBGs extending along the optical fiber 112 with each group of FBGs 114 tuned to reflect a different center wavelength. In these example embodiments where different pairs or group of FBGs 114 are tuned to reflect different center wavelengths to other pairs or groups of FBGs 114, WDM may be used in order to transmit and to receive light from the different pairs or groups of FBGs 114, effectively extending the number of FBG pairs or groups that can be used in series along the optical fiber 112 by reducing the effect of optical loss that otherwise would have resulted from light reflecting from the FBGs 114 located on the fiber 112 nearer to the interrogator 106. When different pairs of the FBGs 114 are not tuned to different center wavelengths, TDM is sufficient.

The interrogator 106 emits laser light with a wavelength selected to be identical or sufficiently near the center wavelength of the FBGs 114, and each of the FBGs 114 partially reflects the light back towards the interrogator 106. The timing of the successively transmitted light pulses is such that the light pulses reflected by the first and second FBGs 114a,b interfere with each other at the interrogator 106, which records the resulting interference signal. The strain that the fiber segment 116 experiences alters the optical path length between the two FBGs 114 and thus causes a phase difference to arise between the two interfering pulses. The resultant optical power at the optical receiver 103 can be used to determine this phase difference. Consequently, the interference signal that the interrogator 106 receives varies with the strain the fiber segment 116 is experiencing, which allows the interrogator 106 to estimate the strain the fiber segment 116 experiences from the received optical power. The interrogator 106 digitizes the phase difference (“output signal”) whose magnitude and frequency vary directly with the magnitude and frequency of the dynamic strain the fiber segment 116 experiences.

The signal processing device 118 is communicatively coupled to the interrogator 106 to receive the output signal. The signal processing device 118 includes a processor 102 and a non-transitory computer-readable medium 104 that are communicatively coupled to each other. An input device 110 and a display 108 interact with the signal processing device 118. The computer-readable medium 104 has stored on it program code to cause the signal processing device 118 to perform any suitable signal processing methods to the output signal. For example, if the fiber segment 116 is laid adjacent a region of interest that is simultaneously experiencing vibration at a rate under 20 Hz and acoustics at a rate over 20 Hz, the fiber segment 116 will experience similar strain and the output signal will comprise a superposition of signals representative of that vibration and those acoustics. The signal processing device 118 may apply to the output signal a low pass filter with a cut-off frequency of 20 Hz, to isolate the vibration portion of the output signal from the acoustics portion of the output signal. Analogously, to isolate the acoustics portion of the output signal from the vibration portion, the signal processing device 118 may apply a high-pass filter with a cut-off frequency of 20 Hz. The signal processing device 118 may also apply more complex signal processing methods to the output signal; example methods include those described in PCT application PCT/CA2012/000018 (publication number WO 2013/102252), the entirety of which is hereby incorporated by reference.

FIG. 1B depicts how the FBGs 114 reflect the light pulse, according to another embodiment in which the optical fiber 112 comprises a third FBG 114c. In FIG. 1B, the second FBG 114b is equidistant from each of the first and third FBGs 114a,c when the fiber 112 is not strained. The light pulse is propagating along the fiber 112 and encounters three different FBGs 114, with each of the FBGs 114 reflecting a portion 115 of the pulse back towards the interrogator 106. In embodiments comprising three or more FBGs 114, the portions of the sensing and reference pulses not reflected by the first and second FBGs 114a,b can reflect off the third FBG 114c and any subsequent FBGs 114, resulting in interferometry that can be used to detect strain along the fiber 112 occurring further from the interrogator 106 than the second FBG 114b. For example, in the embodiment of FIG. 1B, a portion of the sensing pulse not reflected by the first and second FBGs 114a,b can reflect off the third FBG 114c, and a portion of the reference pulse not reflected by the first FBG 114a can reflect off the second FBG 114b, and these reflected pulses can interfere with each other at the interrogator 106.

Any changes to the optical path length of the fiber segment 116 result in a corresponding phase difference between the reflected reference and sensing pulses at the interrogator 106. Since the two reflected pulses are received as one combined interference pulse, the phase difference between them is embedded in the combined signal. This phase information can be extracted using proper signal processing techniques, such as phase demodulation. The relationship between the optical path of the fiber segment 116 and that phase difference (Θ) is as follows:

θ=2πnL/λ,

where n is the index of refraction of the optical fiber, L is the physical path length of the fiber segment 116, and λ is the wavelength of the optical pulses. A change in nL is caused by the fiber experiencing longitudinal strain induced by energy being transferred into the fiber. The source of this energy may be, for example, an object outside of the fiber experiencing dynamic strain, undergoing vibration, or emitting energy. As used herein, “dynamic strain” refers to strain that changes over time. Dynamic strain that has a frequency of between about 5 Hz and about 20 Hz is referred to by persons skilled in the art as “vibration”, dynamic strain that has a frequency of greater than about 20 Hz is referred to by persons skilled in the art as “acoustics”, and dynamic strain that changes at a rate of <1 Hz, such as at 500 μHz, is referred to as “sub-Hz strain”.

One conventional way of determining ΔnL is by using what is broadly referred to as distributed acoustic sensing (“DAS”). DAS involves laying the fiber 112 through or near a region of interest and then sending a coherent laser pulse along the fiber 112. As shown in FIG. 1C, the laser pulse interacts with impurities 113 in the fiber 112, which results in scattered laser light 117 because of Rayleigh scattering. Vibration or acoustics emanating from the region of interest results in a certain length of the fiber becoming strained, and the optical path change along that length varies directly with the magnitude of that strain. Some of the scattered laser light 117 is back-scattered along the fiber 112 and is directed towards the optical receiver 103, and depending on the amount of time required for the scattered light 117 to reach the receiver and the phase of the scattered light 117 as determined at the receiver, the location and magnitude of the vibration or acoustics can be estimated with respect to time. DAS relies on interferometry using the reflected light to estimate the strain the fiber experiences. The amount of light that is reflected is relatively low because it is a subset of the scattered light 117. Consequently, and as evidenced by comparing FIGS. 1B and 1C, Rayleigh scattering transmits less light back towards the optical receiver 103 than using the FBGs 114.

DAS accordingly uses Rayleigh scattering to estimate the magnitude, with respect to time, of the strain experienced by the fiber during an interrogation time window, which is a proxy for the magnitude of the vibration or acoustics emanating from the region of interest. In contrast, the embodiments described herein measure dynamic strain using interferometry resulting from laser light reflected by FBGs 114 that are added to the fiber 112 and that are designed to reflect significantly more of the light than is reflected as a result of Rayleigh scattering. This contrasts with an alternative use of FBGs 114 in which the center wavelengths of the FBGs 114 are monitored to detect any changes that may result to it in response to strain. In the depicted embodiments, groups of the FBGs 114 are located along the fiber 112. A typical FBG can have a reflectivity rating of between 0.1% and 5%. The use of FBG-based interferometry to measure dynamic strain offers several advantages over DAS, in terms of optical performance.

The present disclosure describes methods and systems for detecting moving vehicles travelling on transportation infrastructure by evaluating strain data of an optical fiber disposed at a location in proximity to the transportation infrastructure. The strain data may be obtained using one or more of the techniques described above (i.e. FBGs, DAS, etc.). The strain data is classified, which comprises using a classifier trained to identify a vehicle signature in the strain data indicative of a vehicle travelling on the transportation infrastructure. In some embodiments, the optical fiber is disposed at a location in proximity to a train track, and the classifier is trained to classify the vehicle signature in the strain data as a train signature or a motor vehicle signature travelling on the train track. In other embodiments, the optical fiber is disposed at a location in proximity to a roadway, and the classifier is trained to classify the vehicle signature in the strain data as a motor vehicle signature travelling on the roadway. An occurrence of a vehicle event is determined based on an identification of the vehicle signature in the strain data, and an indication of the vehicle event is output.

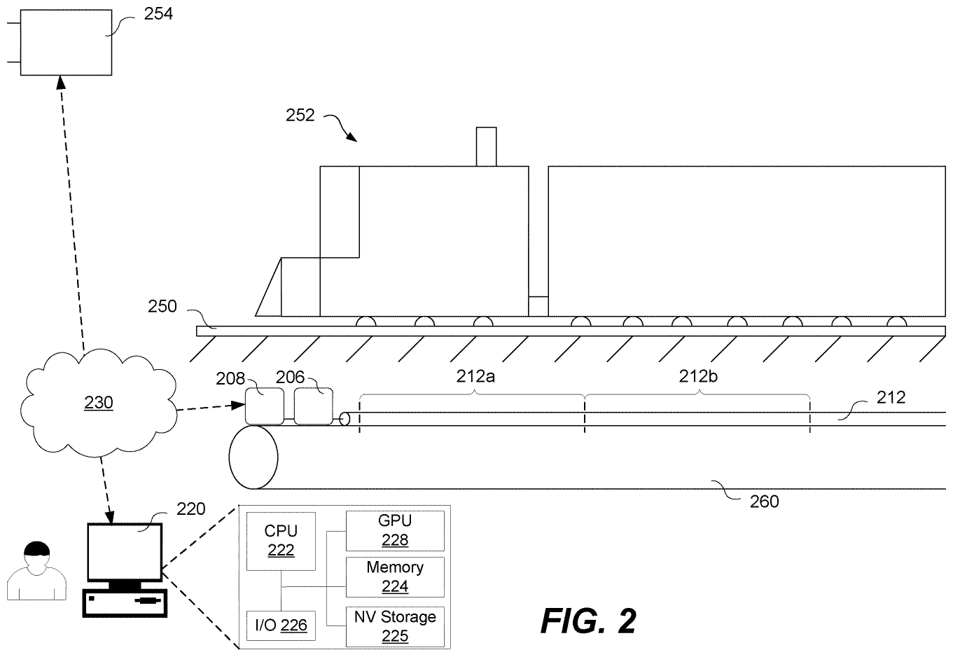

FIG. 2 depicts a representation of a train detection system in accordance with some aspects of the present disclosure. As shown in FIG. 2, an optical fiber 212 is disposed underground at a location in proximity to a train track 250, which has a train 252 travelling thereon. In this exemplary implementation, the optical fiber 212 is disposed along a pipeline 260, and may for example be used for detecting leaks along the pipeline 260 by analyzing strain data (e.g. acoustic signals) of the optical fiber 212. However, in addition to allowing for monitoring the pipeline 260 for leaks, the strain data (e.g. acoustic signals) measured along the optical fiber 212 can be analyzed to detect the train 252. Of course, it will also be appreciated that the optical fiber 212 can be installed at a location in proximity to the train track 250 for the sole purpose of train tracking, i.e. without being installed along a pipeline. The strain data may further be used to determine information about the train including a type of train (Light Rail Transit (LRT) train, freight train, etc.), a speed of the train, and a direction of train travel, as explained in more detail below.

The optical fiber 212 may be disposed parallel to the train track, perpendicular to the train track, or at an angle between parallel and perpendicular to the train track. The optical fiber 212 may be disposed in proximity to the pipeline 260 or directly on the pipeline 260, and may be running along an axial length of the pipeline 260 or wound around the pipeline. Alternatively, the optical fiber 212 may not be installed in relation to a pipeline. It would be appreciated that analysis of the strain data of the optical fiber 212 may be performed according to the specific configuration of the optical fiber relative to the train track 250 (i.e. how the optical fiber is located relative to the train track 250).

In the example implementation shown in FIG. 2, the optical fiber 212 is shown running parallel to the train track 250, and comprises two optical channels, a first optical channel 212a and a second optical channel 212b, corresponding to different fiber segments, along which optical measurements are performed to determine strain data of the optical fiber 212. As described above, an interrogator 206 optically coupled to the optical fiber 212 may be used to perform the optical measurements. The interrogator 206 may employ techniques such as time division multiplexing (TDM) or wavelength division multiplexing (WDM), or a combination of both, to transmit different pulses along the optical fiber. For instance, in the context of WDM, different pulses having different wavelengths may be transmitted along the optical fiber 212. Each optical channel 212a, b of the optical fiber 212 may be provided with a pair of FBGs configured to reflect light having a certain wavelength. Depending on the wavelength of the reflections received from the optical fiber 212, the interrogator 206 may determine from which optical channel 212a,b the reflections originated from. Example lengths of the measurement channels 212a,b of the optical fiber 212 are 12.5 m to 25 m.

Signal processing device 208 is communicatively coupled to the interrogator 206. As previously described, the signal processing device comprises a processor and a non-transitory computer-readable memory that are communicatively coupled to each other. The non-transitory computer-readable memory has stored on it program code to cause the signal processing device 208 to perform any suitable signal processing methods to the output signal. The signal processing device 208 is communicatively coupled with one or more external devices, including the interrogator 206, as well as other devices including remote devices such as an operator device 220 via a communications network 230 such as the Internet.

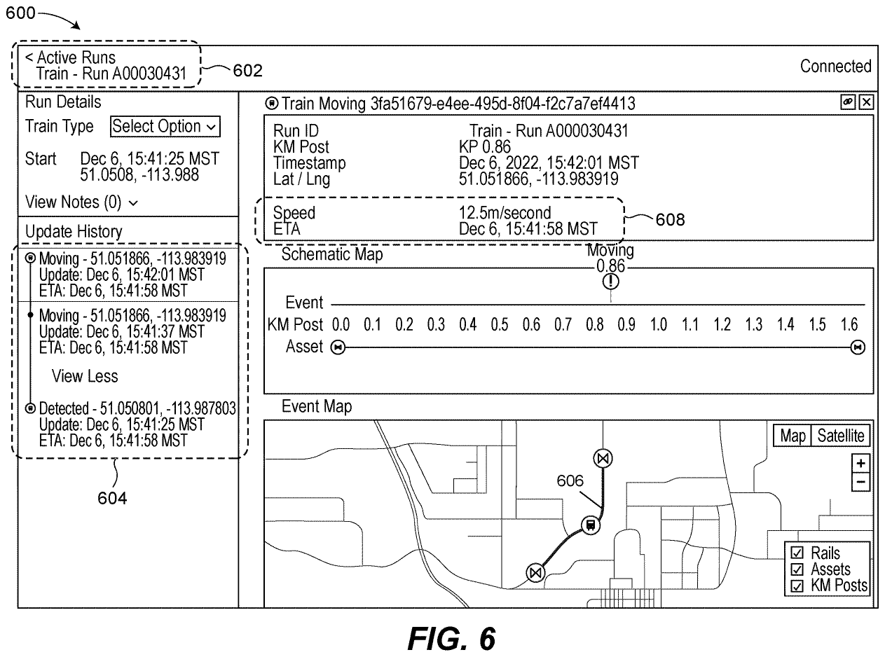

For example, the operator device 220 may receive the output signal produced by the signal processing methods performed by the signal processing device 208, which may for example be a superposition of signals representative of vibration and acoustics experienced in the channels 212a,b over time, or an isolated waveform (e.g. an acoustic waveform). The operator device 220 comprises a processor, e.g. CPU 222, and a non-transitory computer-readable memory 224 that are communicatively coupled to each other. The non-transitory computer-readable memory 224 has stored on it program code at runtime to cause the signal processing device 208 to perform any suitable processing methods to the received data, including a method for vehicle detection, as described in more detail herein. The operator device 220 further comprises non-volatile storage 225 having stored thereon program code that are loaded into the non-transitory computer-readable memory 224 at runtime, and an input/output (I/O) interface 226 for communicating with one or more external devices over the network 240. In one exemplary aspect of the present disclosure, the non-transitory computer-readable memory 224 has computer-executable instructions stored thereon at runtime that when executed by the CPU 222, configure the operator device 220 to perform a method of detecting moving vehicles. The non-transitory computer-readable memory 224 may comprise a classifier stored thereon (e.g. a Random Forrest classifier, a neural network, etc.) as described further herein which may be run to classify the strain data received from the signal processor 208 to identify a vehicle signature indicative of an event (in this case, a train signature corresponding to a train event indicative of the train 252 on the train track 250). The operator device 220 comprises graphical processing units (GPU 228) that controls a display and may be used to run the classifier. The method executed by the operator device 220 may further optionally comprise classifying the train 252 as being a freight train or an light rail transit (LRT) train, and optionally determining a speed and direction of travel of the train 252 on the train track 250. Using the speed and direction of travel of the train 252, the operator device 220 may be further configured to determine an estimated time of arrival of the train 252 at a point of interest, such as a nearby station, and can communicate the estimated time of arrival via network 230 for display on a monitor at one or more stations, such as monitor 254. Real-time vehicle tracking can also be output to a display of the operator device 220, as for example shown in FIG. 6.

It will be appreciated that while a train 252 is being detected in the example embodiment of FIG. 2, the systems and methods described herein can be used for detecting other types of moving vehicles and the classifier trained accordingly, including to classify motor vehicles travelling on the train track 250, and/or motor vehicles (e.g. passenger cars, transport trucks, buses, etc.) travelling on a roadway where the optical fiber 212 is disposed in proximity to a roadway. That is, in some embodiments, in addition to detecting a train event caused by the presence of train 252 on the train track 250, the operator device 220 may be configured to detect other vehicles on the train track from the received strain data, which may include authorized vehicles or unauthorized vehicles. Thus, it will be appreciated that while a train 252 is being detected in the example embodiment of FIG. 2, the systems and methods described herein can be used for detecting other types of moving vehicles and the classifier trained accordingly, including to classify vehicles travelling on the train track 250, and/or vehicles (e.g. passenger cars, transport trucks, buses, etc.) travelling on a roadway where the optical fiber 212 is disposed in proximity to a roadway.

In accordance with further aspects of the present disclosure, it will be appreciated that the optical fiber 212 may be used for detecting other events in addition to detecting trains/vehicles on the train track. For example, the optical fiber 212 may also be used for detecting leaks from pipeline 260, as previously discussed. It is possible that the strain data from the optical fiber 212 indicative of anomalies from the passing of the train 252 may trigger erroneous alarms such as a pipeline leak alarm. In an exemplary implementation, the operator device 220 may be configured to automatically block other alarms associated with the optical fiber 212 when an event is detected to prevent erroneous alarms from being generated.

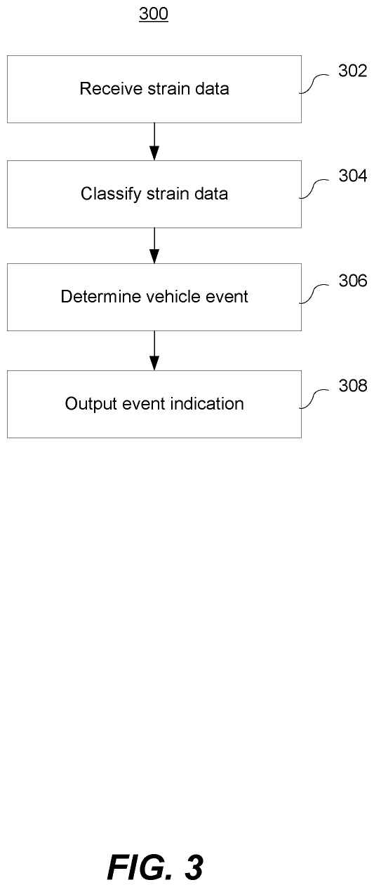

FIG. 3 shows a method of detecting moving vehicles in accordance with embodiments of the present disclosure.

In the method 300, strain data is received from one or more channels of an optical fiber disposed at a location in proximity to transportation infrastructure (e.g. a train track, roadway, etc.) (302). The strain data may be received continuously or in batches. The strain data may be received in real-time or near real-time, and the method executed upon receipt of the strain data, which may be continuously. As described above, the strain data may be received from a strain sensor configured to measure strain in the one or more channels of the optical fiber. The strain sensor may comprise an optical interrogator and at least one pair of fiber Bragg gratings (FBGs), each pair of FBGs corresponding to respective of the one or more channels, and each pair of FBGs tuned to reflect substantially identical wavelengths. The strain data may be received as a signal output from a signal processor. In some aspects, the strain data output may be for a particular frequency region, e.g. acoustic data (i.e. dynamic strain at a frequency of 20 Hz or greater), vibration data (i.e. dynamic strain at a frequency of less than 20 Hz), or both. The strain data may also comprise an identifier that identifies the channel that the strain data corresponds to, as different channels correspond to different locations. In some instances, locations of the channels can be stored in and looked-up from a database using the channel identifier.

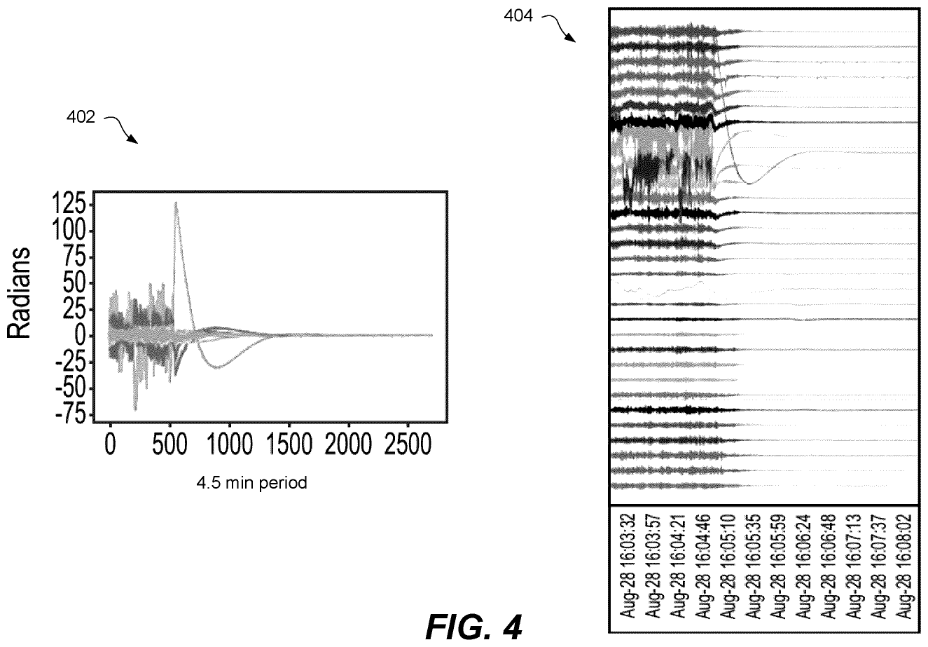

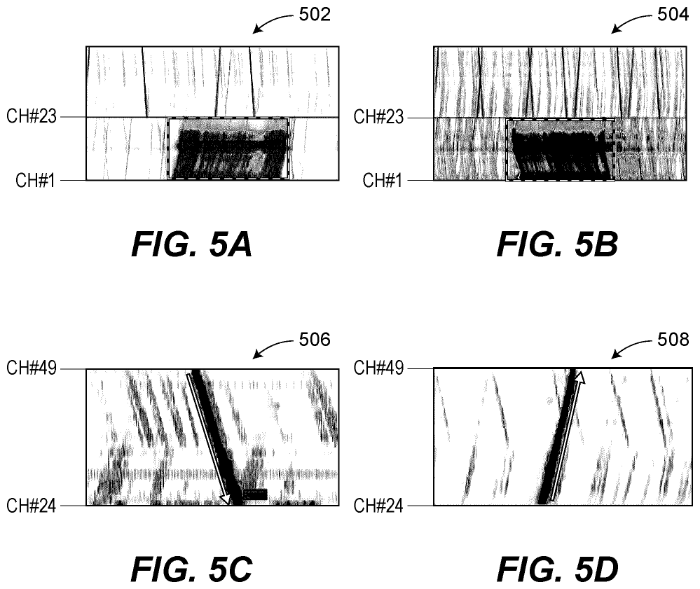

The strain data is classified (304). Classifying the strain data comprises using a classifier that is trained to identify a vehicle signature in the strain data that is indicative of a vehicle travelling on the transportation infrastructure. For example, where the optical fiber is disposed at a location in proximity to a train track, the classifier may be trained to classify the vehicle signature in the strain data as a train signature or as a motor vehicle signature indicative of a motor vehicle travelling on the train track. Where the optical fiber is disposed at a location in proximity to a roadway, the classifier may be trained to classify the vehicle signature in the strain data as a motor vehicle signature travelling on the roadway. In further embodiments, the classifier may be trained to classify the train signature as a freight train or a light rail transit (LRT) train, and/or the motor vehicle signature as a passenger vehicle, a transport truck, or a bus. Examples of strain data comprising train signatures are described in more detail below with reference to FIGS. 4, 5A-D, and 7A and B. For each channel, the machine learning classifier is trained to classify whether the strain data comprises a vehicle signature indicative of a vehicle travelling on the transportation infrastructure. The classifier outputs a classification result, which may for example be a probability, a binary output of vehicle/no vehicle, etc.

In one exemplary implementation, the classifier may comprise a Random Forrest Classifier, which was selected in part because of the nature of the detection problem (specifically that there exists true positives/negatives), and because it provides a simpler solution than other types of classifiers. However, it will be appreciated that other types of classifiers such as neural networks or deep learning could also be used.

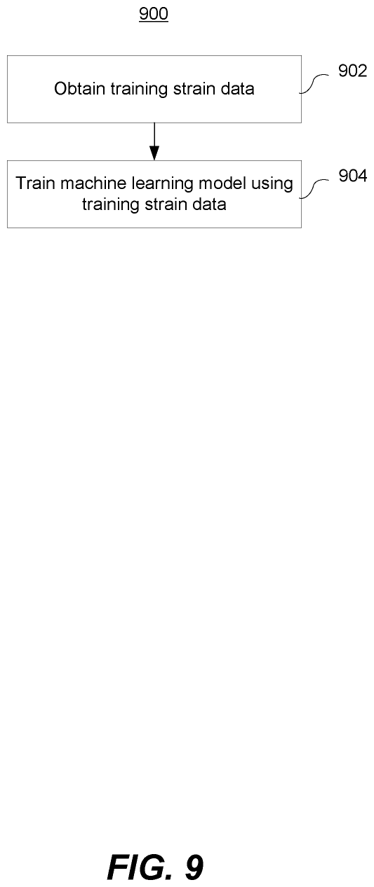

A method of training the classifier is described in detail with reference to FIG. 9 below. In accordance with an exemplary implementation of a system for detecting a moving vehicle in accordance with the present disclosure, a Random Forrest Classifier was trained with 10 trees, a random state set to 0, and 52 maximum features. The 52 maximum features is the square root of 2700, which is the total number of data points in a 4.5 minute sample dataset. Accordingly, for a 4.5 minute dataset, 52 data points were randomly selected from the 2700 available data points, and input into the classifier. A bootstrapping technique may be used for sampling data points. The nodes in the decision trees of the Random Forrest Classifier were derived from the training by attempting to maximize the Gini Gain/index to make splits of data. The decision trees built up with these nodes are therefore trained to classify the strain data by splitting the data at various nodes and generating an output classification. The nodes are thus derived through training to take into account parameters such as magnitude and shape of the strain data in a channel, and optionally magnitude and shape of the strain in adjacent channels when strain data for a plurality of channels is received. It will be appreciated that different datasets may be received and a different number of features may be selected, and that different Random Forrest classifiers could be trained with a different number of trees, nodes, etc. The outputs of the decision trees classify the strain data (e.g. vehicle/no vehicle or undecided) and are aggregated (e.g. based on a majority vote/majority of outputs) to provide the classification result indicative of identification of a vehicle signature caused by a moving vehicle on the transportation infrastructure. The classifier may be further trained to identify a type of vehicle (e.g. train/motor vehicle, and type of train or type of motor vehicle) according to the strain data. For example, a magnitude of strain in a train signature will be greater than a magnitude of strain in a motor vehicle signature; a magnitude of strain in a freight train signature will generally be greater and longer in duration than a magnitude of strain in a LRT train signature and thus have a different shape to the strain data; a magnitude of strain in a transport truck signature will be greater than a magnitude of strain in a passenger vehicle signature; etc. The classifier can thus be used identify a vehicle signature in the strain data for a given channel, including specific types of vehicle signatures.

A determination is made as to whether there is occurrence of a vehicle event based on an identification of vehicle signature(s) in the strain data (306). The determination of the occurrence of the vehicle event may be made by the classifier, or by using a separate deterministic algorithm based on the classifier output. For example, if strain data is received for one channel, and the classifier identifies a vehicle signature (e.g. a train signature) in the strain data, then it may be determined that the vehicle event (i.e. a train event) has occurred. If the strain data is received for a plurality of channels (e.g. 10 channels), then it may be determined that the vehicle event has occurred when the vehicle signature is identified in a threshold percentage (e.g. 50% or more, 66% or more, 80% or more, etc.) of channels. If the strain data is received for a plurality of channels that are arranged parallel to the transportation infrastructure or at an angle between parallel and perpendicular to the transportation infrastructure, the determination of the vehicle event occurrence may be further based on a pattern of channels on which the vehicle signature was identified. For example, a train travelling on a train track will generally be identified along consecutive channels, and will not reverse direction, idle for a time greater than a predetermined idle threshold, etc. Accordingly, if the channels on which the vehicle signature was identified indicate: (a) movement on the train track that reverses direction; (b) movement on the train track that changes to an idle for a time greater than a predetermined idle threshold; or (c) movement on the train track for a time greater than a predetermined train passing threshold, then this may be indicative of a motor vehicle on the train track instead of a train. Determining occurrence of the vehicle event may be further based on the strain data satisfying a corresponding strain magnitude threshold. For example, the strain data may be evaluated against one or more strain magnitude thresholds that are set to distinguish vehicle movement on the transportation infrastructure (e.g. a freight train may have a first strain magnitude threshold, a LRT train may have a second, lower strain magnitude threshold than the first, and a motor vehicle may have a third, lower strain magnitude threshold than the second). The strain magnitude thresholds may be an acoustic strain magnitude threshold and/or an absolute strain magnitude threshold. The strain magnitude threshold may be set relative to pre-defined baselines from mean, max, or root-mean-squared (RMS) data, i.e. by observing a number of signatures and determining an appropriate minimum threshold. Different strain magnitude thresholds could be set for different types of vehicles.

Determining the occurrence of the vehicle event at 306 thus validates/confirms the classifier output. If a vehicle signature is detected by the classifier on some channels but not others, such that less than the threshold percentage of channels is satisfied, then it may be determined that there was no vehicle event. If the classifier classifies the strain data as comprising a train signature, but a pattern of channels on which the vehicle signature was identified indicates that the train reversed direction, then it may be determined that the vehicle event is in fact a motor vehicle on the train track instead of a train, or the type of vehicle event may be undecided. Similarly, if the classifier classifies the strain data as comprising a freight train signature, but the strain magnitude threshold for a freight train is not satisfied, it may instead be determined that the vehicle event is an LRT train event, or the type of vehicle may be undecided.

The method 300 comprises outputting an indication of the vehicle event (308). The indication of the vehicle event may include a type of the vehicle event (e.g. train event, or more specifically freight train event), or may indicate if there is an uncertainty.

In the method 300, when a vehicle event is identified by the channel(s) of the optical fiber, one or more features associated with the vehicle event may be determined, such as a speed of the vehicle, and a direction of the vehicle. For example, when the optical fiber is disposed parallel to the transportation infrastructure or at an angle between perpendicular and parallel to the transportation infrastructure, and the optical fiber has a plurality of channels, the strain data from multiple channels may be used to evaluate the speed and/or direction of the vehicle travel. For example, a speed of the vehicle may be determined based on a time between identifying the vehicle signature on different channels; a direction of the vehicle may be determined based on an order of channels on which the vehicle signature was identified. When the optical fiber is disposed perpendicular to the transportation infrastructure, strain data from a second optical fiber disposed at a second location in proximity to the transportation infrastructure may be received and used to determine one or both of the speed and the direction of the vehicle from the strain data of the optical fiber in conjunction with the strain data from the second optical fiber. The method may further comprise determining, from the speed and direction of travel, an estimated time of arrival of the vehicle at a point of interest, such as an ETA of a train arriving at a nearby train station. Computing the estimated time of arrival based on strain data obtained in response to the train passing near the optical fiber provides for a more accurate estimation as the estimation is based on real-time train crossing the optical fiber. This would be advantageous, for example, in the case where the point of interest is a train station where communicating the estimated time of arrival to the train station allows the train station to update its estimated time of arrival. The method may also comprise communicating the estimated time of arrival to the point of interest.

FIG. 4 shows an example of train detection using strain data in accordance with embodiments of the present disclosure. In FIG. 4, the strain data is shown in the graph 402 as an acoustic signal in units of radians representing the phase difference that arises between the two interfering pulses in optical interferometry when strain is introduced in the fiber. As previously discussed, as sound waves interact with the optical fiber, strain is induced in the optical fiber that changes a path length of the optical fiber between the fiber Bragg gratings (FBGs) and is detected by the phase difference between the two interfering pulses. Accordingly, when a train (or other vehicle) passes by the optical fiber located in proximity to the train track or transportation infrastructure, the strain resulting along the optical fiber is detected. The strain data is continuously measured and evaluated over periods, such as 4.5 minutes as shown in the graph 402. In this example, the strain data is measured at a rate of 10,000 Hz but down-sampled to 10 Hz, i.e. one time sample every 0.1 seconds, resulting in 2700 data points over the 4.5 minute period.

As described above, the optical fiber may comprise one or more channels on which strain is measured. Each channel of the optical fiber has a pair of FBGs used for measuring strain. In the example data collected in FIG. 4, there are 30 channels of the optical fiber, and the optical fiber is arranged perpendicularly to the train track. Accordingly, as seen in FIG. 4, as the train passes the magnitude of the strain recorded at each of the channels increases well-above baseline mean, max, or RMS strain data. The strain data for the individual channels is shown in the plot 404.

As noted above, each channel may for example be between 1 to 25 meters in length. Accordingly, in situations where the optical fiber is arranged perpendicular to the train track, the magnitude of the strain detected at channels further away from the location that the train passed overhead will decrease compared to channels located closer to the location where the train passed overhead. It will also be appreciated that the magnitude of the strain is related to the type of train on the train track, as a heavier, longer train will induce a larger amount of strain in the optical fiber that lasts for a longer period of time. Accordingly, the classifier can also classify the type of train on the train track.

The strain data for each of the channels is input to the classifier described above, which classifies the strain data based on the location of the channel to predict whether a train has passed by the channel. Table 1 below shows the results of the classifier for each channel.

TABLE 1

[[1 0], [1 0], [1 0], [1 0], [1 0], [1 0], [1 0],
[1 0], [1 0], [1 0], [1 0], [1 0], [0 1], [0 1], [1 0],
[1 0], [1 0], [1 0], [1 0], [1 0], [1 0], [1 0], [1 0],
[1 0], [1 0], [1 0], [1 0], [1 0], [1 0], [1 0]]

As seen by the table above, the classifier correctly predicted (i.e. [1 0]) on 28 of the 30 channels that the train passed, while for 2 of the 30 channels predicted incorrectly (i.e. [0 1]). The accuracy of the classifier in this case is 28/30=93%. As described above, the method may require that the classifier predict that the train has passed on a certain percentage of channels (e.g. greater than 66%, greater than 80%, etc.) before outputting an indication of the train passing. It will also be appreciated that strain data from only a subset of channels along the length of the optical fiber may be used to improve accuracy of the results, such as only channels within 500 m of the train track, which may be specified.

FIGS. 5A-D show examples of strain data of train events in accordance with embodiments of the present disclosure. There are four plots 500a, 500b, 500c, and 500d shown in FIGS. 5A-D, respectively. Each of the plots have channel number on the y-axis, time on the x-axis, and a magnitude of strain indicated by the colour/shading within the plot. These plots depict train signatures for different types of trains moving in various directions. These train signatures for each channel may be used for training the classifier. During training, training strain data, which has a known train signature, is input to the classifier being trained to identify train signatures. The classifier may then be trained to classify the strain data using the training strain data. As used herein, “test” strain data refers to strain data input to the classifier in order to test performance of the classifier, while “training” strain data refers to strain data input to the classifier to train the model. A generic reference to “strain data” may refer to test strain data, training strain data, and/or the strain data received from the optical fiber for detection of events when the classifier is deployed, depending on the context.

When the optical fiber is disposed parallel to a train track, information such as a speed of the train and a direction of the train can be determined based on which channels detect the train and when. For example, a time between detecting the train at adjacent channels can be used to determine a speed of the train travel. An order of the channels that detect the train can be used to determine a direction of the train travel. When one channel indicates a train event, strain data from adjacent channels can be buffered. The same applies for optical fibers that are disposed at an angle between parallel and perpendicular to the train track, where appropriate correction factors can be applied in the speed calculation to account for the angle of the optical fiber relative to the train track. Where the optical fiber is disposed perpendicular to the train track, strain data from consecutive optical fibers can be used to determine a speed and direction of the train travel.

The train signatures in FIGS. 5A-D were obtained from channels of an optical fiber arranged parallel to the train track, which is in a North-East/South-West direction in this example. FIG. 5A shows a RMS signature of a freight train travelling North-East. In the plot 502 shown in FIG. 5A, strain data indicative of a train passing is first detected on Channel #1, and is detected last on Channel #23, indicative of the train travelling NE. The time between detection of the train event on different channels can be used to determine the speed of the train travel. The length of the time that the strain is detected on the channels can be used to classify the type of train, in this case a freight train. FIG. 5B shows a RMS signature of a freight train travelling South-West. In the plot 504, the strain data indicative of a train passing is first detected on Channel #23, and is detected last on Channel #1, indicative of the train travelling SW. FIG. 5C shows a RMS signature of a LRT train travelling South-West. FIG. 5D shows a RMS signature of a LRT train travelling North-East. As seen in the FIGS. 5A and 5B compared to FIGS. 5C and 5D, a freight train produces a larger and more pronounced signature than an LRT train.

FIG. 6 shows an example of a user interface 600 generated in accordance with embodiments of the present disclosure. The user interface 600 is shown as monitoring/tracking a train event, and may for example be displayed at the operator computer 220 in the system as shown in FIG. 2.

When a train event is detected by an optical fiber, a flag may be generated and stored in association with the time and location of the optical fiber that detected the train. The data from the optical fiber (or channel) adjacent to the location of the optical fiber (or channel) that detected the train is buffered, and if there are ongoing flags which show a distinct slope, the speed can be determined, using the stored time and location data from the time of the initial flag, as well as the time and location data from the most recent flag. After the speed of the new train movement is determined, an estimated time of arrival (ETA) can be calculated, knowing the distance between the most recent detected location of the train, and the desired point of interest.

When a new, distinguishable train with a slope showing movement is confirmed by the classifier, an individual Train ID is applied to the train activity, and updates for the location/speed of the train can be generated until the train leaves the monitoring zone. The process is repeated for each new train detected.

As seen in FIG. 6, the user interface 600 shows a train ID at 602, updates 604, providing continuous updates output by the classifier regarding the location of the train throughout a monitoring zone, a map 606 showing the train in motion, and a speed calculation and ETA 608 based upon data computed in real-time. Accordingly, the user interface 600 provides real-time tracking of the train. As will also be appreciated, the user interface 600 can be used for tracking/monitoring other types of moving vehicles detected from strain data in accordance with the present disclosure.

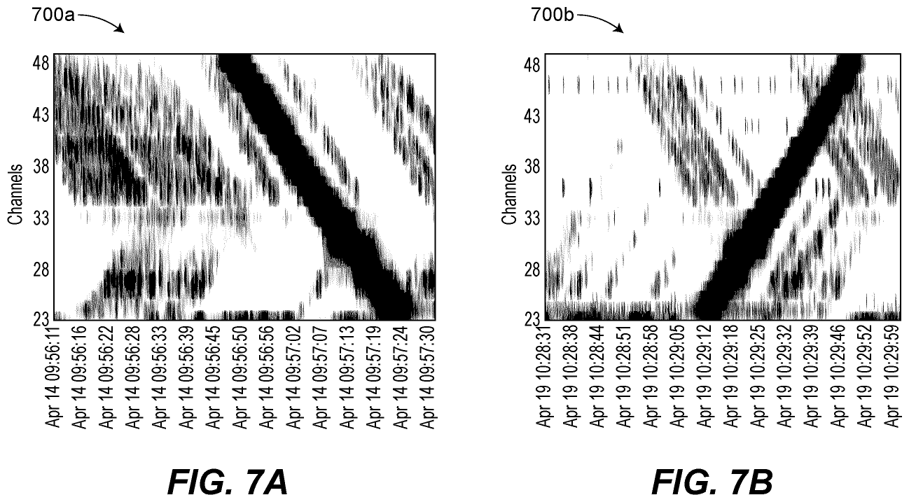

FIGS. 7A and 7B show strain data obtained for testing the classifier. The strain data was obtained from an optical fiber located between two train stations along a LRT line. Existing LRT train arrival times generated by the transport authority were found to often be up to a few minutes off. The classifier was tested to see if it could produce a more accurate ETA.

FIG. 7A shows an acoustic plot 702 comprising two minutes of strain data obtained from testing, which show a train event. The train detection log produced by the classifier produced the following data:
Train detection: heading Eastbound
Initial flag detected at 10:56:55 at channel 39
Estimated time to leave monitoring zone based upon baseline-calculated speed: 10:57:30
Estimated time to reach station based upon the baseline-calculated speed: 10:58:13.

The measured times for the same train were as follows:
Time the train arrived at the station platform while moving: 10:58:09.
Time the train came to a complete stop at station platform: 10:58:25.

Accordingly, the predicted Time of Arrival at the Station was 10:58:13, and the actual Time of Arrival at the Station was 10:58:09.

Based upon the real-time data, the classifier produced an accurate prediction (within a few seconds) as to when the train should have arrived at the Station for this run.

FIG. 7B shows an acoustic plot comprising two minutes of strain data obtained from testing, which show a train event. The train detection log produced by the classifier produced the following data:
Train detection: heading Westbound
Initial flag detected at 11:29:11 at channel 24
Estimated time to leave monitoring zone based upon baseline-calculated speed: 11:29:51
Estimated time to reach station based upon the baseline-calculated speed: 11:30:13.

The measured times for the same train were as follows:
Time the train arrived at the station platform while moving: 11:30:12.
Time the train came to a complete stop at station platform: 11:30:20.

Accordingly, the predicted Time of Arrival at the Station was 11:30:13, and the actual Time of Arrival at the Station was 11:30:12.

Based upon the real-time data, the classifier produced an accurate prediction (within a few seconds) as to when the Train should have arrived at the Station for this run.

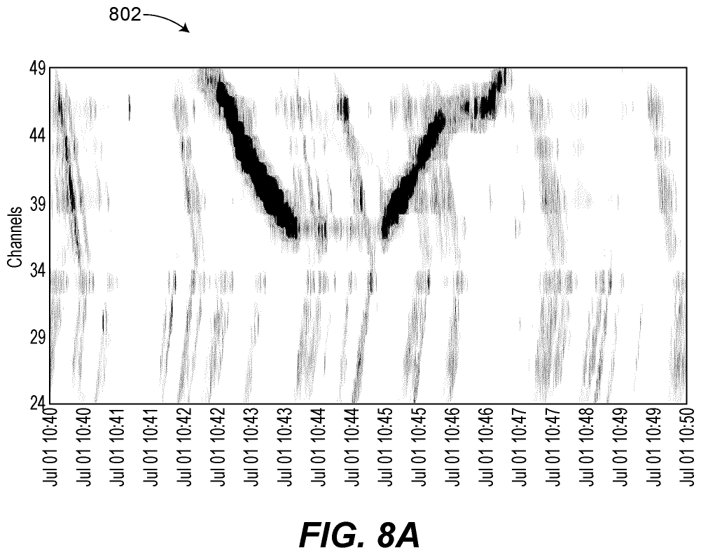

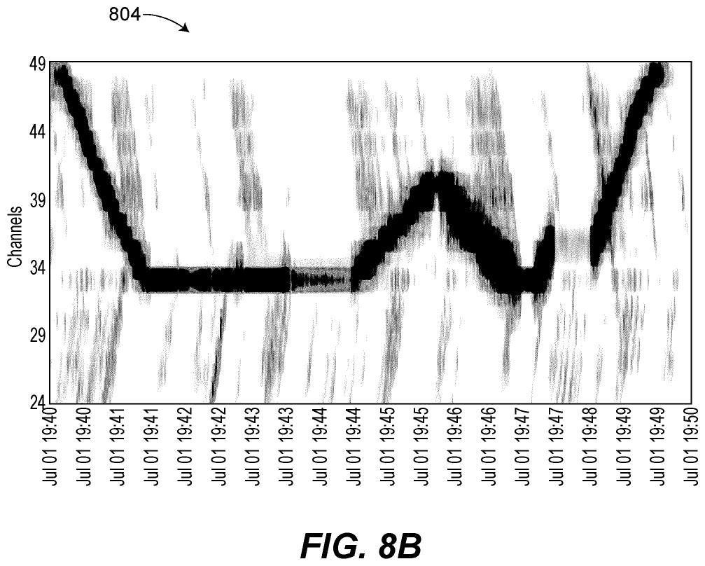

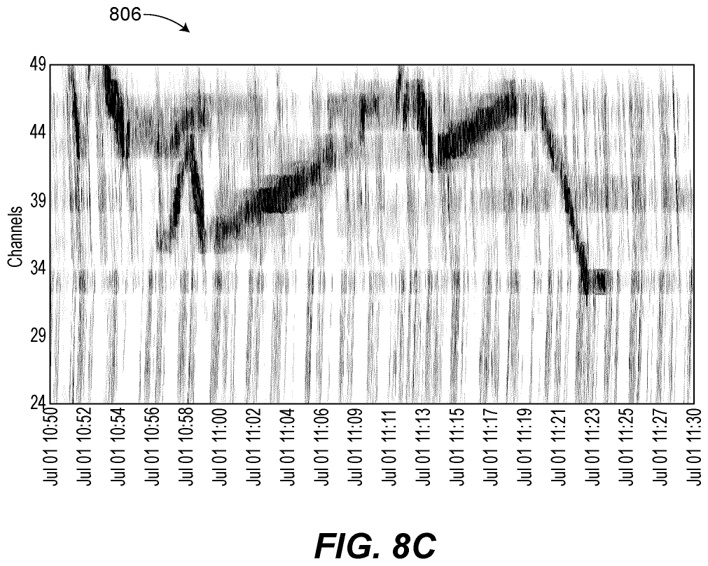

FIGS. 8A-C show examples of strain data of a motor vehicle detected on a train track in accordance with embodiments of the present disclosure. As described previously, authorized or unauthorized vehicle movement along train lines (particularly LRT) can be detected in a few different ways, and the classifier or a deterministic algorithm can be trained to classify vehicle signatures indicative of a vehicle travelling on a train track. For example, a vehicle travelling on a train track will induce lower magnitude of strain than a train travelling on the train track, which can be classified by the classifier. In addition to producing different magnitudes of strain, a pattern of channels on which a vehicle signature is identified will be different if the vehicle is a train compared to a vehicle. For example, a vehicle signature indicative of a vehicle travelling on a train track may be identified in part by detecting at least one of: (a) movement on the train track that reverses direction; (b) movement on the train track that changes to an idle for a time greater than a predetermined idle threshold; and (c) movement on the train track that lasts for a time greater than a predetermined train passing threshold. Other events indicative of a vehicle (that is not a train) may also be used in identification of the vehicle.

For example, if a vehicle signature is identified by the classifier (and optionally the acoustic and absolute strain anomalies may be met) but then the movement reverses direction, as shown in plot 802 in FIG. 8A, this may be indicative of a motor vehicle on the train track as trains should generally not abruptly reverse direction. If a vehicle signature is identified by the classifier (and optionally the acoustic and absolute strain anomalies may be met) but then the source producing the vehicle signature begins to idle at one channel, as shown in plot 804 in FIG. 8B, this may be indicative of a motor vehicle on the train tracks as trains, particularly LRT trains, typically do not idle in place between stations for extended periods of time. Further, if a vehicle signature is detected in one direction (and optionally the acoustic and absolute strain anomalies may be met) but then the source producing the movement does not exit the fiber monitoring zone in the typical time it takes for a train to pass through the zone, as shown in plot 806 in FIG. 8C, this may be indicative of a motor vehicle as a train should have exited the monitoring zone within a threshold amount of time. Accordingly, a vehicle event may be determined to be a motor vehicle on the train track by detecting one more of the above-noted patterns in vehicle signatures. As described above, strain magnitude thresholds set for different types of vehicles may also be used to determine/validate that the vehicle event is a motor vehicle on the train track.

FIG. 9 shows a method 900 of training a classifier in accordance with embodiments of the present disclosure.

In order to train the classifier, training strain data is obtained (902), which has a known vehicle signature. The training strain data may comprise strain data from one or more channels of an optical fiber. The known vehicle signature may comprise a known train signature and/or a known motor vehicle signature obtained from an optical fiber with a defined orientation (e.g. parallel, perpendicular, or at an angle between parallel and perpendicular) relative to the transportation infrastructure. The known train signature may more specifically be a known freight train signature and/or a known LRT train signature. As an example, the train signatures shown in FIGS. 5A-D may be used as known train signatures and used to train the classifier for classifying trains and further classifying types of trains using strain data received from channels of an optical fiber running parallel to the train track. The known motor vehicle signature may more specifically be a known passenger vehicle signature, a known transport truck signature, and/or a known bus signature. The classifier is then trained to classify the vehicle signature using the training strain data (904).

In accordance with the present disclosure, acoustic strain data was used to train the Random Forrest Classifier. Data samples of 4.5-minutes (2700 data points per sample, each sample in radians) were extracted, with each sample either containing signatures of vehicles or of no vehicles. The training data is labelled and input into the classifier. The label may simply be train/no train, or vehicle/no vehicle, or may be a specific class of train/vehicle (e.g. freight train, LRT train, passenger vehicle, transport truck, bus, etc.). For training the classifier to identify train signatures, 5% of the total samples collected had train signatures, while the other 95% of the collected samples had no train signatures within them (ambient or noisy data). An imbalanced training data set was used. For the currently trained models, 20% of the collected samples were used for model training, while the other 80% of samples were used to test the model and ensure the models were making accurate predictions.

The embodiments have been described above with reference to flowcharts and block diagrams of methods, apparatuses, systems, and computer program products. In this regard, the flowcharts and block diagrams in the figures illustrate the architecture, functionality, and operation of possible implementations of various embodiments. For instance, each block of the flowcharts and block diagrams may represent a module, segment, or portion of code, which comprises one or more executable instructions for implementing the specified logical function(s). In some alternative embodiments, the functions noted in that block may occur out of the order noted in those figures. For example, two blocks shown in succession may, in some embodiments, be executed substantially concurrently, or the blocks may sometimes be executed in the reverse order, depending upon the functionality involved. Some specific examples of the foregoing have been noted above but those noted examples are not necessarily the only examples. Each block of the block diagrams and flowcharts, and combinations of those blocks, may be implemented by special purpose hardware-based systems that perform the specified functions or acts, or combinations of special purpose hardware and computer instructions.

Each block of the flowcharts and block diagrams and combinations thereof can be implemented by computer program instructions. These computer program instructions may be provided to a processing apparatus of a general-purpose computer, special-purpose computer, or other programmable data processing apparatus to produce a machine, such that the instructions, which execute via the processing apparatus of the computer or other programmable data-processing apparatus, create means for implementing the functions or acts specified in the blocks of the flowcharts and block diagrams. The processing apparatus may comprise any suitable processing unit such as a processor, microprocessor, programmable logic controller, a microcontroller (which comprises both a processing unit and a non-transitory computer readable medium), or system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

These computer program instructions may also be stored in a computer-readable medium that can direct a computer, other programmable data-processing apparatus, or other devices to function in a particular manner, such that the instructions stored in the computer-readable medium produce an article of manufacture including instructions that implement the function or act specified in the blocks of the flowcharts and block diagrams. The computer program instructions may also be loaded onto a computer, other programmable data-processing apparatus, or other devices to cause a series of operational steps to be performed on the computer, other programmable apparatus or other devices to produce a computer-implemented process such that the instructions that execute on the computer or other programmable apparatus provide processes for implementing the functions or acts specified in the blocks of the flowcharts and block diagrams.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

While the disclosure has been described in connection with specific embodiments, it is to be understood that the disclosure is not limited to these embodiments, and that alterations, modifications, and variations of these embodiments may be carried out by the skilled person without departing from the scope of the disclosure. It is furthermore contemplated that any part of any aspect or embodiment discussed in this specification can be implemented or combined with any part of any other aspect or embodiment discussed in this specification, so long as those parts are not mutually exclusive.

1. A method of detecting moving vehicles, comprising:
receiving strain data from one or more channels of an optical fiber disposed at a location in proximity to transportation infrastructure;
classifying the strain data, wherein classifying the strain data comprises using a classifier trained to identify a vehicle signature in the strain data indicative of a vehicle travelling on the transportation infrastructure;
determining occurrence of a vehicle event based on an identification of the vehicle signature in the strain data; and
outputting an indication of the vehicle event.

2. The method of claim 1, wherein classifying the strain data comprises classifying the strain data received from each of the one or more channels respectively.

3. The method of claim 1, wherein the strain data is received from a plurality of channels of the optical fiber arranged perpendicular to the transportation infrastructure, and wherein the vehicle event is determined to have occurred when the vehicle signature is identified in a threshold percentage of the plurality of channels.

4. The method of claim 1, wherein the strain data is received from a plurality of channels of the optical fiber arranged parallel or at an angle between parallel and perpendicular to the transportation infrastructure, and wherein the vehicle event is determined to have occurred based on a pattern of channels on which the vehicle signature was identified.

5. The method of claim 4, further comprising determining one or both of:
a speed of the vehicle, based on a time between identifying the vehicle signature on different channels; and
a direction of the vehicle, based on an order of channels on which the vehicle signature was identified.

6. The method of claim 5, further comprising determining an estimated time of arrival of the vehicle at a point of interest based on the speed of the vehicle and the direction of the vehicle.

7. The method of claim 4, wherein the transportation infrastructure is a train track, and the method comprises determining that the vehicle event is caused by a motor vehicle on the train track by detecting at least one of the following based on the pattern of channels on which the vehicle signature was identified:
(a) movement on the train track that reverses direction;
(b) movement on the train track that changes to an idle for a time greater than a predetermined idle threshold; and
(c) movement on the train track for a time greater than a predetermined train passing threshold.

8. The method of claim 1, wherein the transportation infrastructure is a train track, and the classifier is trained to classify the vehicle signature in the strain data as a train signature or a motor vehicle signature travelling on the train track.

9. The method of claim 8, wherein the classifier is further trained to classify the train signature as corresponding to a freight train or a light rail transit train.

10. The method of claim 1, wherein the transportation infrastructure is a roadway, and the classifier is trained to classify the vehicle signature in the strain data as a motor vehicle signature travelling on the roadway.

11. The method of claim 10, wherein the classifier is further trained to classify the motor vehicle signature according to a type of vehicle comprising one of: a passenger vehicle, a transport truck, and a bus.

12. The method of claim 1, further comprising:
evaluating the strain data against one or more strain magnitude thresholds, the strain magnitude thresholds set to distinguish vehicle movement on the transportation infrastructure; and
wherein determining occurrence of the vehicle event is further based on the strain data satisfying the corresponding strain magnitude threshold.

13. The train detection method of claim 12, wherein the one or more strain magnitude thresholds comprise one or more of an acoustic strain threshold and an absolute strain threshold.

14. The method of claim 1, wherein the strain data classified by the classifier is an acoustic signal measured in the one or more channels of the optical fiber.

15. The method of claim 1, wherein the strain data is received from a strain sensor configured to measure strain in the one or more channels of the optical fiber, the strain sensor comprising an optical interrogator and at least one pair of fiber Bragg gratings (FBGs), each pair of FBGs corresponding to respective of the one or more channels, and each pair of FBGs tuned to reflect substantially identical wavelengths.

16. A non-transitory computer readable medium having stored thereon computer program code that is executable by a processor and that, when executed by the processor, causes the processor to perform a method of detecting moving vehicles, comprising:
receiving strain data from one or more channels of an optical fiber disposed at a location in proximity to transportation infrastructure;
classifying the strain data, wherein classifying the strain data comprises using a classifier trained to identify a vehicle signature in the strain data indicative of a vehicle travelling on the transportation infrastructure;
determining occurrence of a vehicle event based on an identification of the vehicle signature in the strain data; and
outputting an indication of the vehicle event.

17. A vehicle detection system, comprising:
an optical fiber disposed at a location in proximity to transportation infrastructure, the optical fiber comprising one or more channels each having at least one pair of fiber Bragg gratings tuned to reflect substantially identical wavelengths;
an optical interrogator optically coupled to the optical fiber and configured to perform optical interferometry using the optical fiber; and
a processing device communicatively coupled to the optical interrogator, wherein the processing device is configured to perform the method of a method of detecting moving vehicles, comprising:
receiving strain data from one or more channels of an optical fiber disposed at a location in proximity to transportation infrastructure;
classifying the strain data, wherein classifying the strain data comprises using a classifier trained to identify a vehicle signature in the strain data indicative of a vehicle travelling on the transportation infrastructure;
determining occurrence of a vehicle event based on an identification of the vehicle signature in the strain data; and
outputting an indication of the vehicle event.

18. A method of training a classifier to classify strain data received from one or more channels of an optical fiber and to identify a vehicle signature in the strain data, the method comprising:
obtaining training strain data, wherein the training strain data has a known vehicle signature; and
training the classifier to classify the vehicle signature using the training strain data.

19. The method of claim 18, wherein the known vehicle signature is at least one of a known train signature and a known motor vehicle signature.

20. The method of claim 19, wherein the known train signature comprises one or both of a known freight train signature and a known light rail transit train signature.

21. The method of claim 19, wherein the known motor vehicle signature comprises one or more of a known passenger vehicle signature, a known transport truck signature, and a known bus signature.
